(19) United States
(12) Patent Application Publication
(10) Pub. No.: US 2020/0296901 A1
(43) Pub. Date: Sep. 24, 2020

(54) Upside-Down Planter

(71) Applicant: Larry Landry, Greenacres, WA (US)

(72) Inventor: Larry Landry, Greenacres, WA (US)

(21) Appl. No.: 16/357,107

(22) Filed: Mar. 18, 2019

(51) Int. Cl. A01G 9/02; A47G 7/04

(52) U.S. Cl. CPC A01G 9/024; A47G 7/047

(57) ABSTRACT

This disclosure includes an upside-down planter with a body having an upper end opposite a lower end. The body includes at least two separate and discrete sections secured together to define a cavity. Support cables are secured to the upper end of the body. An opening in the lower end of the body is configured to receive a portion of a plant. At least one mechanical fastener releasably secures the at least two sections of the body together.

### CROSS REFERENCE TO RELATED APPLICATION

This application does not claim priority from any other application.

### TECHNICAL FIELD

The subject matter of this application relates to upside-down planters.

### BACKGROUND OF THE DISCLOSURE

Upside-down planters have numerous advantages that account for their popularity, for example, to save space, fewer weeds and relocation opportunities. However, proponents and opponents alike agree that there is a major disadvantage: low production. Once the soil and plant are provided in the planter, access to the interior of the planter is difficult if not impossible and such access would increase production drastically since any soil and root system deficiencies can be addressed. Designs for upside-down planters are needed to address this disadvantage.

While the subject matter of this application was motivated in addressing disadvantages associated with upside-down planters, it is in no way so limited. The disclosure is only limited by the accompanying claims as literally worded, without interpretative or other limiting reference to the specification, and in accordance with the doctrine of equivalents.

Other aspects and implementations are contemplated.

### BRIEF DESCRIPTION OF THE DRAWINGS

Exemplary embodiments of the various disclosures are described below with reference to the following accompanying drawings. The drawings may be considered to represent scale.

FIG. 1 illustrates a perspective view of an inventive upside-down planter according to one non-limiting embodiment of the invention;

FIG. 2 is a portion of a side sectional view of the FIG. 1 invention;

FIG. 3 is a front side elevation view of the FIG. 1 invention;

FIG. 4 is a rear side elevation view of the FIG. 1 invention;

FIG. 5 is a top plan view of the FIG. 1 invention;

FIG. 6 is a bottom plan view of the FIG. 1 invention;

FIG. 7 is an exploded view of the FIG. 1 invention;

FIG. 8 is a partial sectional view of an exemplary component of the FIG. 1 invention according to an embodiment of the invention;

FIG. 9 is a partial sectional view of an exemplary component of the FIG. 1 invention according to an embodiment of the invention;

FIG. 10 is a partial sectional view of an exemplary component of the FIG. 1 invention according to an embodiment of the invention;

FIG. 11 is a partial sectional view of an exemplary component of the FIG. 1 invention according to an embodiment of the invention;

FIG. 12 illustrates an exemplary method step of use of the upside-down invention according to an embodiment of the invention;

FIG. 13 illustrates an exemplary method step of use of the upside-down invention, subsequent to the method step of FIG. 12, according to an embodiment of the invention;

FIG. 14 illustrates an exemplary method step of use of the upside-down invention, subsequent to the method step of FIG. 13, according to an embodiment of the invention;

FIG. 15 illustrates an exemplary method step of use of the upside-down invention, subsequent to the method step of FIG. 14, according to an embodiment of the invention;

FIG. 16 illustrates an exemplary method step of use of the upside-down invention, subsequent to the method step of FIG. 15, according to an embodiment of the invention;

FIG. 17 is a partial sectional view of an exemplary component of the invention according to a non-limiting embodiment of the invention;

FIG. 18 is a partial sectional view of an exemplary component of the invention according to a non-limiting embodiment of the invention;

FIG. 19 is a partial sectional view of an exemplary component of the invention according to a non-limiting embodiment of the invention;

FIG. 20 illustrates an exploded perspective view of an inventive upside-down planter according to another non-limiting embodiment of the invention;

FIG. 21 illustrates a side elevational view of an inventive upside-down planter according to another non-limiting embodiment of the invention;

FIG. 22 illustrates a side elevational view of an inventive upside-down planter according to another non-limiting embodiment of the invention;

FIG. 23 illustrates a side elevational view of an inventive upside-down planter according to another non-limiting embodiment of the invention; and

FIG. 24 illustrates a side elevational view of an inventive upside-down planter according to another non-limiting embodiment of the invention.

### DETAILED DESCRIPTION OF THE EMBODIMENTS

This disclosure is submitted in furtherance of the constitutional purposes of the U.S. Patent Laws “to promote the progress of science and useful arts” (Article 1, Section 8).

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

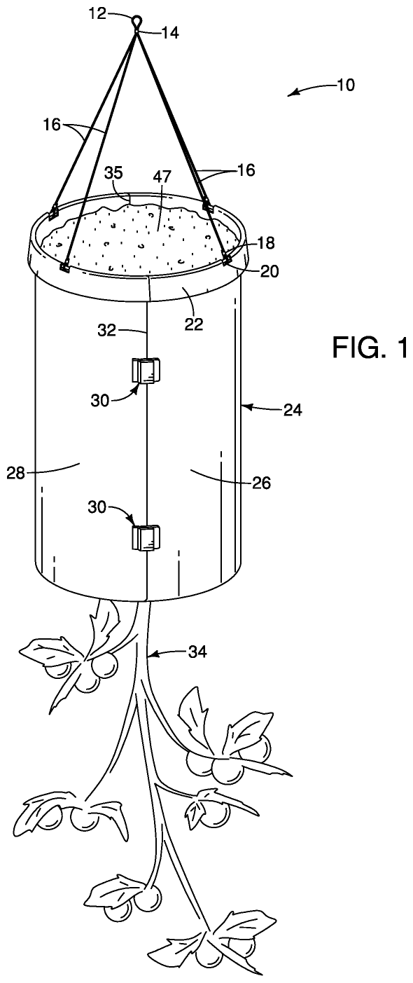

Referring to FIG. 1, an exemplary planter 10 is illustrated according to one non-limiting embodiment of the invention. A major structure of the planter 10 is a body or housing (or container) 24 that defines a cavity (from this view, cavity shown to be at least partially filled with soil 47). In one exemplary embodiment, the body 24 is configured as a cylinder having a circular horizontal cross section. It should be understood that other horizontal cross-section configurations are contemplated for the body 24, including any geometric configurations, such as polygons, quadrilaterals, parallelograms, triangles, pentagons, squares, rectangles, hexagons, pentagons, tetragons, etc.

Still referring to FIG. 1 and for this exemplary embodiment, the body 24 is configured as two halves or sections 26 (first section) and 28 (second section) exhibiting a pair of sectional lines 32 and 35 extending vertically when in a closed position (in this closed position, the body 24 defines the cavity). That is, the first section 26 is a separate and discrete structure relative to the second section 28. The sections 26 and 28 are secured together by mechanical fasteners and/or locking mechanisms (discussed more thoroughly subsequently) including latches and hinges.

Still referring to FIG. 1, it should be understood that body 24 may be comprised of more than two sections, or none at all. For example, the body 24 of planter 10 can be a continuous structure having no sections. Alternatively, the body 24 of planter 10 can comprise three sections, four sections, five sections, six sections, etc. As discussed previously, each section would be secured to an adjacent section by mechanical fasteners and/or locking mechanisms. In the embodiment shown, the two sections 26 and 28 are releasably secured together by a pair of mechanical fasteners (locking mechanisms). Exemplary mechanical fasteners are latches 30 vertically spaced apart over sectional line 32. In this embodiment, the latches 30 are flexible biasing latches 30 described more thoroughly subsequently.

Still referring to FIG. 1 and referring to a method of use for planter 10, soil 47 is provided through the top of the body 24 and a plant 34 having roots in the soil 47 extends from the bottom or lower end of the body 24. At the top or upper end of the body 24 of planter 10 is a rim collar 22 having openings to receive ends of support lines or cables 16. One end of each support cable 16 is a loop end 18 that slidingly engages a support ring 20 secured under the rim collar 22. Each support cable 16 extends from the support ring 20 to have opposite ends meet at a retaining collar 14. Rotational secured in the retaining collar 14 is a swivel loop 12 that is capable of rotating 360 degrees.

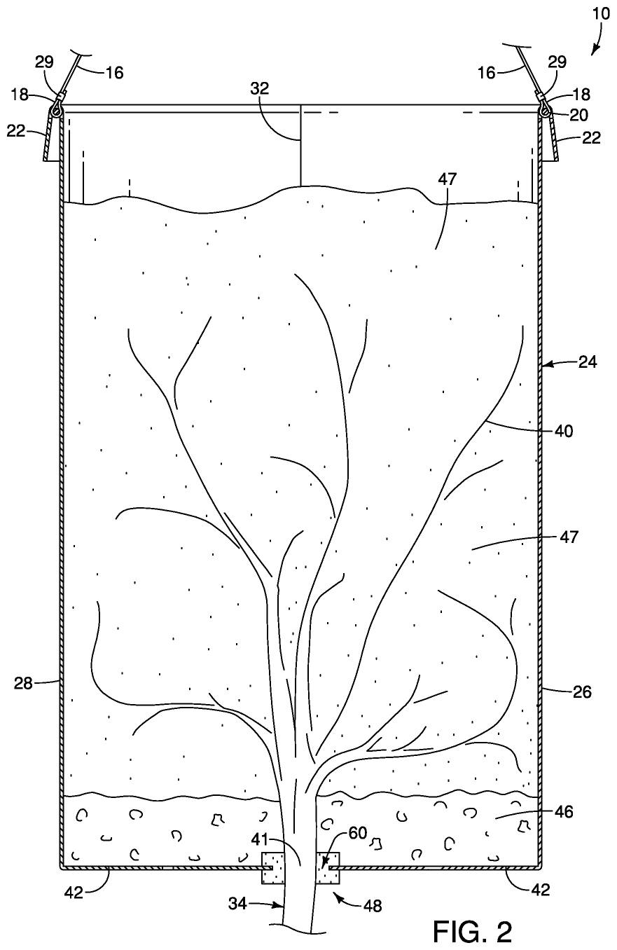

Referring to FIG. 2, the sectional view illustrates an exemplary use of the planter 10. In this embodiment, soil 47 is elevationally above another material 46. Material 46 may be a different material entirely such as fertilizer or could be a different soil material having a different composition or consistency. In other embodiments, soil 47 can be beneath material 46. In other embodiments still, there can be a different number of layers of material inside planter 10 including only soil 47 or only material 46, or one or more layers of material in addition to soil 47 and material 46 at various elevational levels.

Still referring to FIG. 2, rim collar 22 is illustrated as being formed by material of body 24 being bent or folded over with support ring 20 at the apex. An exemplary material for support ring 20 is a metal or a plastic such as a thermoformed plastic. In one embodiment, support ring 20 is retained at the apex of rim collar 22 by tension from the support cables 16. In this embodiment, the support ring 20 is able to slide along the apex of the rim collar 22 and around the body 24 of the planter 10. In other embodiments, support ring 20 is secured to the rim collar 22 by an adhesive. Each loop end 18 of the support cables 16 has a loop collar 29. While the rim collar 22 is integral with the material of the body 24 of the planter 10, other embodiments are contemplated. For example, the rim collar 22 can be a separate and discrete structure secured to a top portion of the body 24 by an adhesive.

Still referring to FIG. 2, the body 24 of planter 10 has a bottom wall (floor) 42 with an opening 60. A seal 48 (shown and described more thoroughly subsequently) is removably secured in opening 60 and receives a portion of plant 34, and in this case, the stem 41 of plant 34. Roots 40 and stem 41 of plant 34 are illustrated extending through material 46 and soil 47.

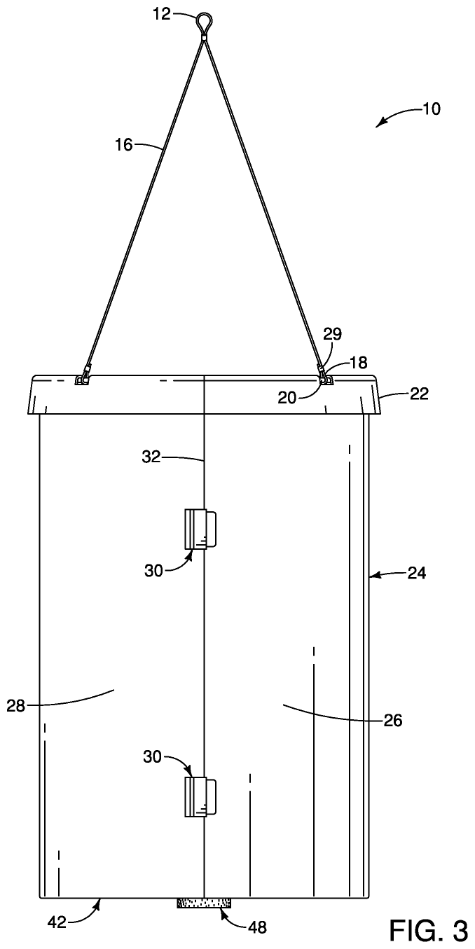

Referring to FIG. 3, a front side of planter 10 is illustrated and characterized by latches 30. Seal 48 can be seen extending from opening 60 (not referenced here) of bottom wall 42 of body 24. It should be understood that the seal 48 can be thought of as a bushing between the plant 34 and the bottom wall 42 of the body 24.

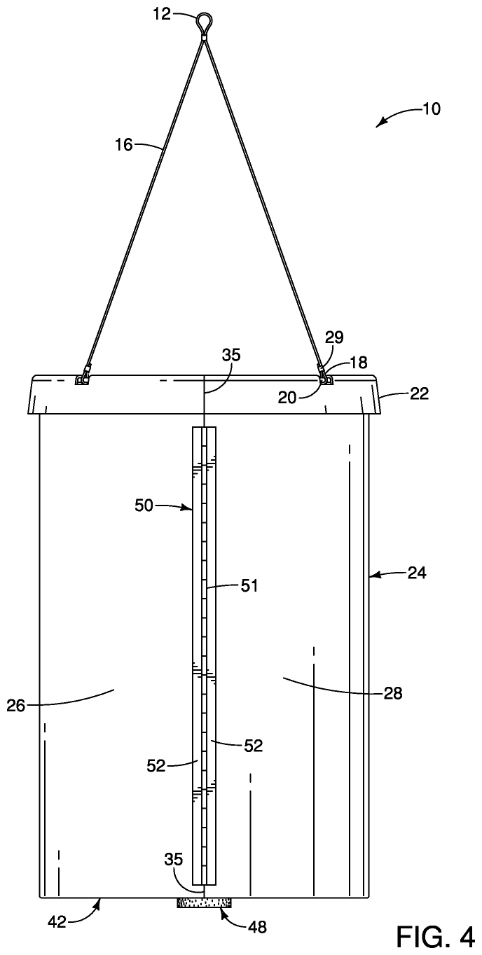

Referring to FIG. 4, a rear side of planter 10 is illustrated and characterized by a mechanical bearing 50 not previously referenced or described. An exemplary mechanical bearing 50 is a hinge that extends along sectional line 35 of body 24 and connects sections 26 and 28 of body 24. Hinge 50 has a pair of leaves 52, one leaf 52 secured to section 26 and the other leaf 52 secured to section 28. Both leaves 52 are secured to, or integral with, the knuckle 51 of hinge 50. Knuckle 51 is hollow and receives a pin (not show or referenced) that extends through the knuckle 51 and provides the rotation or pivot action of hinge 50, and correspondingly, sections 26 and 28 of planter 10. It should be understood that while one continuous structure for hinge 50 is shown, other embodiments are contemplated such as a plurality of smaller hinges 50 secured to sections 26 and 28 along sectional line 35. Still further, other types of mechanical bearings or hinges are contemplated such as: a coach hinge, a H hinge, a tee hinge, a HL hinge, a counterflap hinge, a self-closing hinge, a double action spring hinge, etc. It should be understood that in embodiments of the planter 10 with some of these other hinges, such as a double action spring hinge, the latches 30 may not be needed to maintain the sections 26 and 28 of planter 10 in a closed orientation.

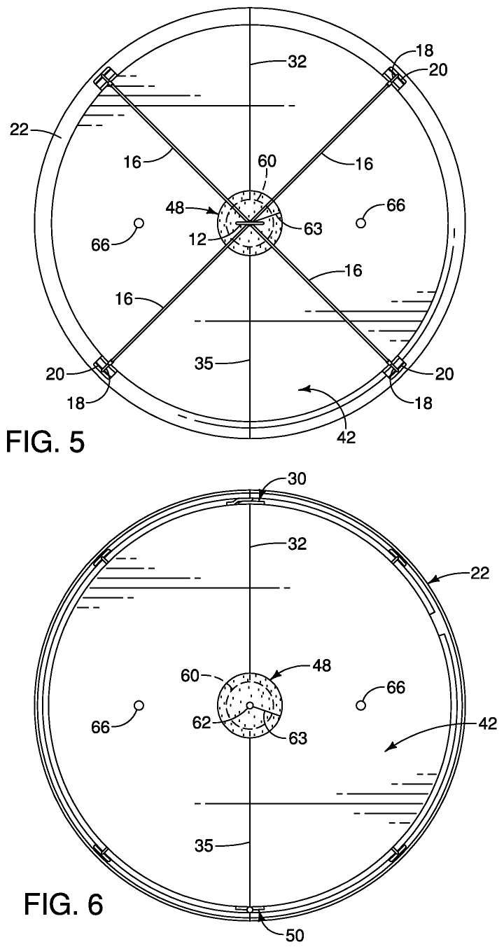

Referring to FIGS. 5 and 6, top and bottom views of planter 10, respectively, are shown without soil 47 and material 46. One or more small openings 66 in bottom wall 42 are provided for ventilation. Seal 48 is shown with a slot 63 extending from a periphery of seal 48 to a centrally located opening 62. The slot 63 allows the seal 48 to be opened (spread apart) to receive a plant ultimately in opening 62.

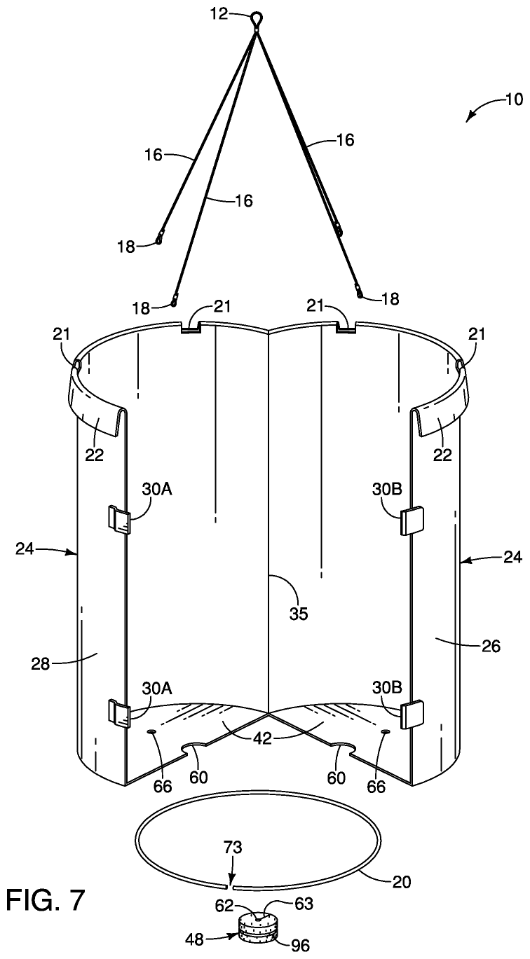

Referring to FIG. 7, an exploded view of planter 10 is illustrated. The two components 30A and 30B of each latch 30 is shown and described more thoroughly subsequently. Support ring 20 is shown as not a continuous structure having a discontinuous region 73 which allows for slightly opening or spreading apart support ring 20 to facilitate positioning the support ring 20 over the body 24 of planter 10 into the rim collar 22. Opening 60 is readily shown having a half of opening 60 in bottom wall 42 of section 26 and an other half of opening 60 in bottom wall 42 of section 28. Rim collar 22 is shown with gaps 21 configured to receive loop ends 18 of respective support cables 16 which have engaged support ring 20.

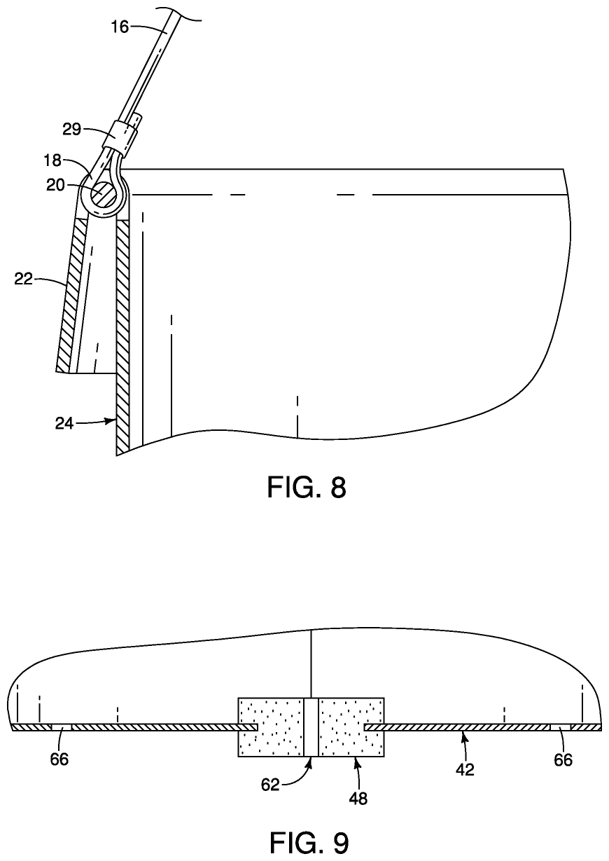

Referring to FIG. 8, a close-up view of the interaction of the loop ends 18 of respective support cables 16 engaging support ring 20 is illustrated.

Referring to FIG. 9, a close-up view of the seal 48 secured in the bottom wall 42 of planter 10 is illustrated. It should be understood that a groove (not shown or referenced) is formed around the periphery of the seal 48 to receive the periphery portions of opening 60 established in the bottom wall 42.

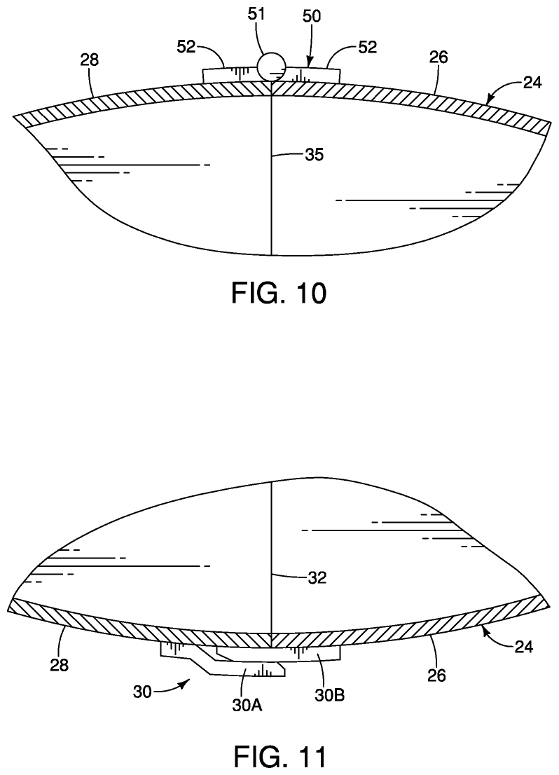

Referring to FIG. 10, a sectional view of body 24 is illustrated to emphasize the top view structure of the hinge 50.

Referring to FIG. 11, a sectional view of body 24 is illustrated to emphasize the structure of one latch 30 of the pair. An exemplary latch 30 has a base 30B attached (secured) to section 26 and a flexible biasing member 30A attached (secured) to section 28. The flexible biasing member 30A is biased toward body 24, and therefore, in the closed orientation shown, applies pressure on base 30B to maintain sections 26 and 28 in the closed orientation.

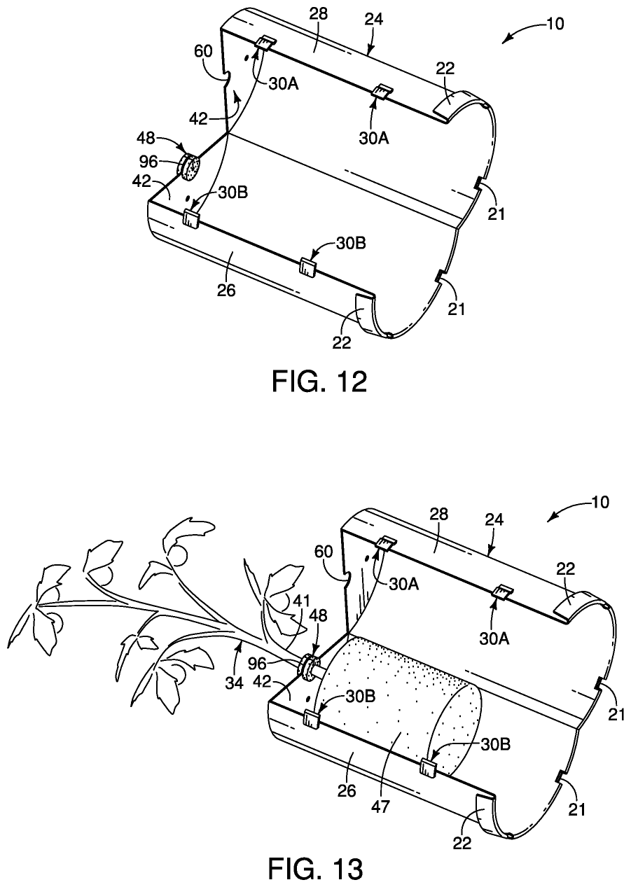

Referring to FIGS. 12-16, a method of use for planter 10 is shown and described. Referring to FIG. 12, planter 10 is in the open orientation wherein from the closed orientation (see FIG. 11), a force was applied to sections 26 and 28 to spread the sections apart. The force on sections 26 and 28 needs to overcome the force component provided by the biasing of latches 30. Periphery groove 96, discussed previously, in seal 48 is shown for the first time which receives bottom wall 42 portions defining opening 60.

Referring to FIG. 13, a plant 34 with soil 47 on the roots placed in the cavity defined by the body 24 of planter 10. The stem 41 of plant 34 is placed in the slot and opening of seal 48 (see FIG. 6).

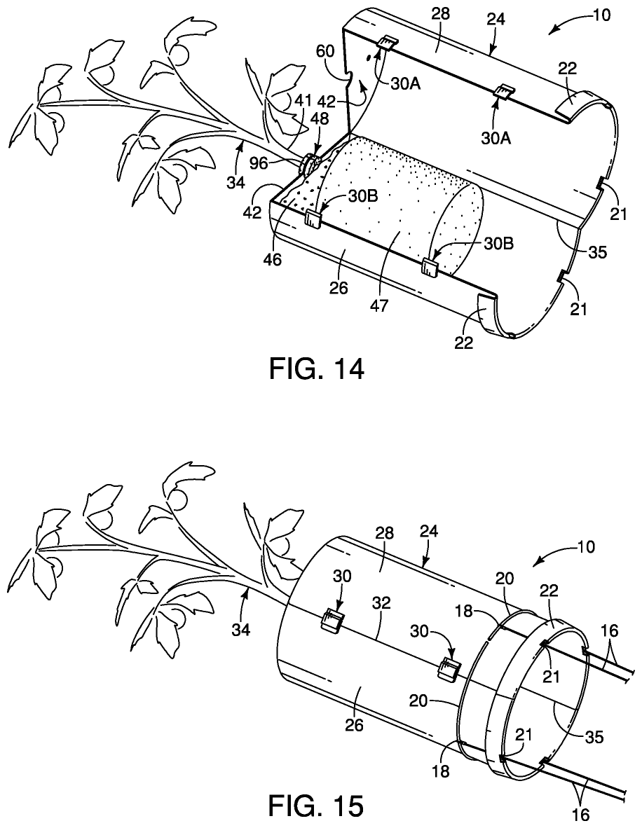

Referring to FIG. 14, optional material 46 is provided in the space of the cavity between the bottom wall 42 and soil 47.

Referring to FIG. 15, sections 26 and 28 of body 24 are pivoted toward each other until latch components 30A and 30B engage to maintain the planter 10 in the closed orientation. In this closed orientation, sectional line 32 is established again. The loop ends 18 of the support cables 16 are provided on support ring 20 and the opposite ends of the support cables 16 are provided through the gaps 21 of rim collar 22.

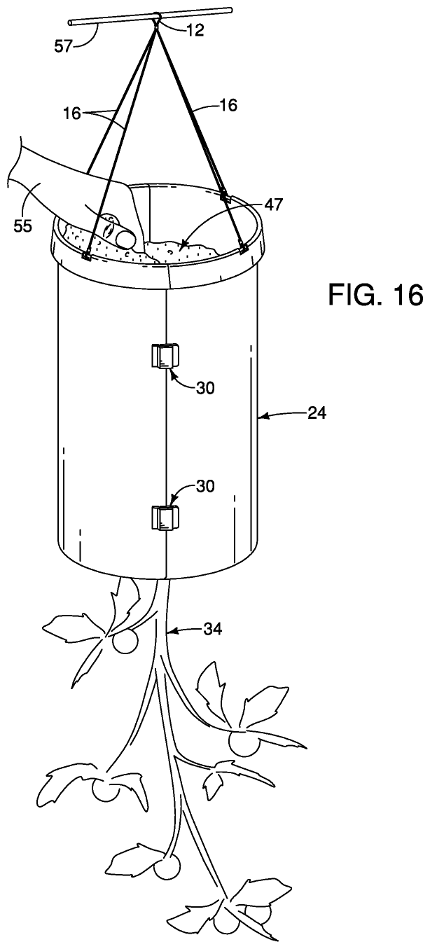

Referring to FIG. 16, swivel loop 12 is provided over a support structure 57 such as a rod or hook. Shown in this figure is a hand 55 manipulating the soil 47.

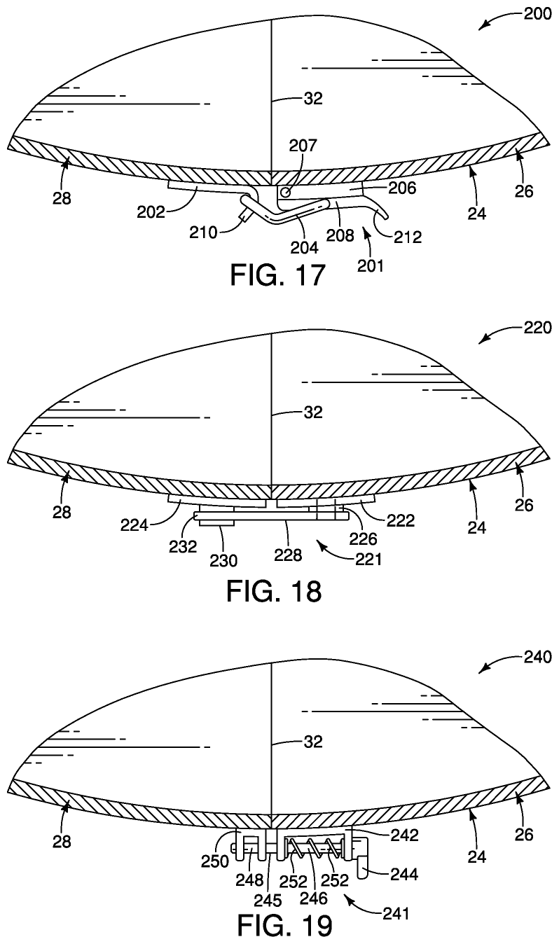

Referring to FIGS. 17-19, exemplary different mechanical fasteners (locking mechanisms) are shown and described according to various non-limiting embodiments of the invention.

Referring to FIG. 17, a portion of a planter 200 is illustrated with a mechanical fastener 201. Mechanical fastener 201 has a base 206 secured to a first section of planter 200 and a hook 202 that is secured to a second section of the planter 200. Hook 202 has a curved portion (hook) 210. Base 206 has a lever 208 capable of pivot action on pivot pin 207. Lever 208 pivots in the plane of the page (pivot axis is perpendicular to the plane of the page) and includes a finger portion 212 configured for finger engagement. Mechanical fastener 201 has a drawer 204 with one end that is secured in lever 208 and an opposite end that engages the curved portion 210 of hook 202 in a locked/closed position when the lever 208 is resting against the base 206 as shown. In this locked/closed position, the first and second sections of body 24 of planter 200 are pressed, locked and closed together.

Still referring to FIG. 17, to unlock the mechanical fastener 201, the finger portion 212 is engaged to lift the lever 208 from the base 206 and pivot the lever 208 about pivot pin 207 (lever 208 pivots in the plane of the page). Pivoting the lever 208 in this manner moves the drawer 204 in the left direction (from this view) and releases the drawer 204 from the hook 202 and curved portion 210. Releasing the drawer 204 from hook 202 unlocks the mechanical fastener 201 and releases the first section of the body 24 from being pressed against the second section. In this manner, the body 24 and planter 200 are in the open/released orientation/position.

Referring to FIG. 18, a portion of a planter 220 is illustrated with a mechanical fastener 221. Mechanical fastener 221 has a first base 222 secured to a first section of planter 220 and a second base 224 that is secured to a second section of the planter 220. The second base 224 has an engagement member 230 extending upwardly from the second base 224. Base 222 includes a pivot pin 226 and a drawer 228 pivotably secured on pivot pin 226. Drawer 228 pivots out of the plane of the page (pivot axis is in the plane of the page). One end of the drawer 228 is secured on pivot pin 226 and an opposite end 232 engages the engagement member 230 of second base 224 in a locked/closed position as shown. In this locked/closed position, the first and second sections of body 24 of planter 220 are pressed, locked and closed together.

Still referring to FIG. 18, to unlock the mechanical fastener 221, the drawer 228 is engaged to pivot the end 232 of drawer 228 away from the engagement member 230 (drawer 228 pivots out of the plane of the page). Pivoting the drawer 228 in this manner releases the drawer 228 from the engagement member 230 and the second base 224 and thereby unlocks the mechanical fastener 221. Unlocking the mechanical fastener 221 releases the first section of the body 24 from being pressed against the second section. In this manner, the body 24 and planter 220 are in the open/released orientation/position.

Referring to FIG. 19, a portion of a planter 240 is illustrated with a mechanical fastener 241. Mechanical fastener 241 has a first base 242 secured to a first section 26 of planter 240 and a second base 250 that is secured to a second section 28 of the planter 240. Both first and second bases 242 and 250 have central linear segments that provide the securement to the respective first and second sections 26 and 28. At opposite ends of each central linear segment are pin supports that extend perpendicularly from the respective central linear segments of the respective first and second bases 242 and 250. A longitudinal draw pin 245 has a first portion 246 that extends through the pin supports of the first base 242 and the draw pin 245 has a second portion 248 that extends through the pin supports of the second base 250.

Still referring to FIG. 19, a spring 252 extends over the first portion 246 of the draw pin 245 between the pin supports of the first base 242. It should be understood that draw pin 245 is capable of sliding along the longitudinal axis, back and forth, through the first and second bases 242 and 250. Moreover, the draw pin 245 is capable of rotating about the longitudinal axis. A terminal end of the draw pin 245 is a finger member 244 outside the first base 242 to facilitate engagement of the draw pin 245 to enact the sliding and/or the rotation. While not seen in this view, it should be understood that the second portion 248 of the draw pin 245 has a knob is received in a groove in the second base 250 which keeps the second section 28 pressed against the first section 26 and maintains the body 24 in the closed, locked orientation shown. However, rotating the draw pin 245 until the knob is released from the groove in the second base 250 allows the spring 252 to bias the second base 250 away from the first base 242, and therefore, moves the second section 28 of the body 24 away from the first section 26 thereby opening the body 24 and the planter 240.

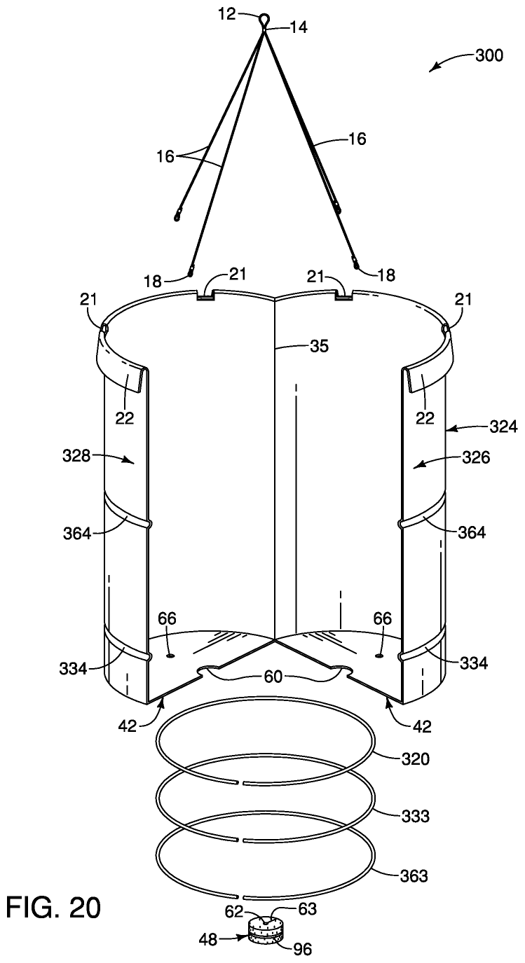

Referring to FIG. 20, an exemplary planter 300 is illustrated according to another non-limiting embodiment of the invention. The reference numbers used in this figure that are the same reference numbers as used previously represent the same structures/components already described. Accordingly, the structures/components having the same reference numbers may not be described again.

Still referring to FIG. 20, in this view, planter 300 is in the open orientation/position. A body 324 of the planter 300 is configured with at least two halves or sections 326 (first section) and 328 (second section). Moreover, the planter 300 has at least one groove surrounding the circumferential periphery of the body 324. In this embodiment, there are at least two grooves 364 and 334 surrounding the circumferential periphery of the body 324. To close planter 300, section 326 and section 328 are pressed together to close body 324 and establish the closed orientation/position. Next, a support ring 320 is provided over the body 324 and positioned under the rim collar 22. Then at least one retaining ring is provided in at least one of the grooves to secure the sections 326 and 328 together in the closed orientation. In this embodiment, a first retaining ring 333 is provided in groove 364 and a second retaining ring 363 is provided in groove 334. In this manner, the body 324 remains in the closed, locked orientation wherein the first and second retaining rings 333 and 363 function as the mechanical fasteners described in the previous embodiments as latches. It should be understood that in this embodiment, a single mechanical fastener can secure the sections 326 and 328 together in the closed orientation. Moreover, more than two grooves and retaining rings are contemplated for other embodiments.

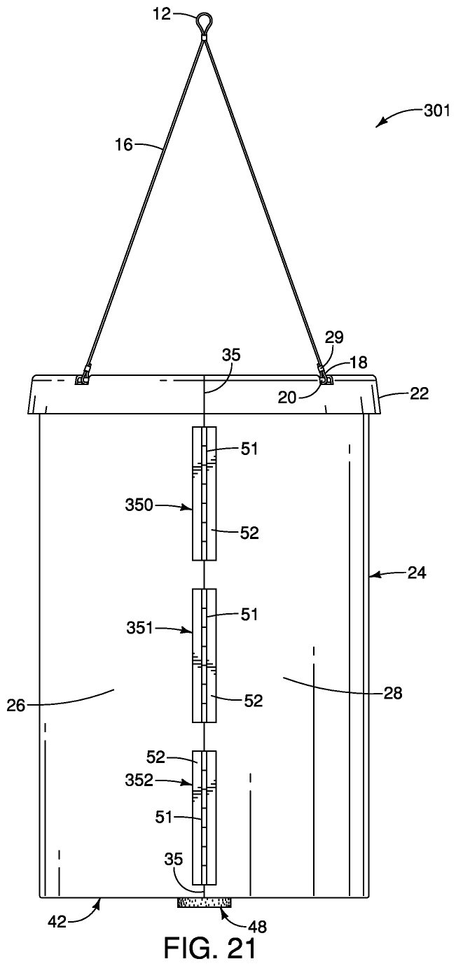

It should be understood that any of the planters described throughout this document can have any number, and any style or configuration, of mechanical fasteners along any of the sectional lines of the planter. It should be further understood that each sectional line can have the same, or differently configured, mechanical fasteners. In fact, the hinges over each sectional line 35 of FIGS. 4 and 21 can be replaced with any of the latches described throughout this document.

Referring to FIG. 21, an exemplary planter 301 is illustrated according to another non-limiting embodiment of the invention. The reference numbers used in this figure that are the same reference numbers as used previously represent the same structures/components already described. Accordingly, the structures/components having the same reference numbers may not be described again.

Still referring to FIG. 21, a rear side view of planter 310 is illustrated and characterized by having at least two or more hinges that extend along sectional line 35 of body 24. In this embodiment, hinges 350, 351 and 352 connect sections 26 and 28 of body 24. It should be understood that there can be two hinges, or more hinges, depending on the length of the body of the planter.

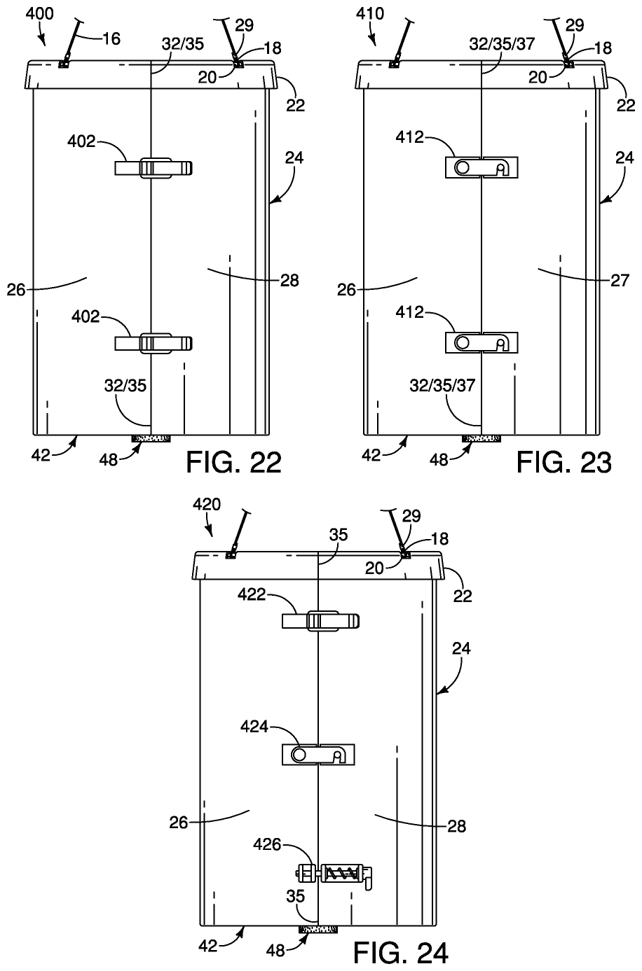

Referring to FIG. 22, an exemplary planter 400 is illustrated according to another non-limiting embodiment of the invention. The reference numbers used in this figure that are the same reference numbers as used previously represent the same structures/components already described. Accordingly, the structures/components having the same reference numbers may not be described again.

Still referring to FIG. 22, planter 400 is illustrated and characterized as having at least two mechanical fasteners 402 over one, or both, of sectional lines 32 and 35 of body 24. It should be understood that over one, or both, of sectional lines 32 and 35 of body 24, there can be two of the same mechanical fasteners as shown, or two different mechanical fasteners. Moreover, it should be understood that over one, or both, of sectional lines 32 and 35 of body 24, there can be only one mechanical fastener, or three or more mechanical fasteners with any combination of mechanical fasteners being the same, or different, configurations.

Referring to FIG. 23, an exemplary planter 410 is illustrated according to another non-limiting embodiment of the invention. The reference numbers used in this figure that are the same reference numbers as used previously represent the same structures/components already described. Accordingly, the structures/components having the same reference numbers may not be described again.

Still referring to FIG. 23, planter 410 is illustrated and characterized as having at least three sectional lines 32, 35 and 37. Accordingly, body 24 of planter 410 has three sections 26, 27 and 28 (section 28 not shown or referenced). Mechanical fasteners 412 are over one, or more, of sectional lines 32, 35 and 37 of body 24. It should be understood that over one, two or all, of the sectional lines 32, 35 and 37, there can be one, two or more of the same mechanical fasteners; or one, two or more different mechanical fasteners in any combination.

It should be understood that any planter described throughout this document can have any number of sections with any number of sectional lines. Moreover, it should be understood that any planter described throughout this document can have any number of mechanical fasteners secured to the planter body over one or more of the sectional lines.

Referring to FIG. 24, an exemplary planter 420 is illustrated according to another non-limiting embodiment of the invention. The reference numbers used in this figure that are the same reference numbers as used previously represent the same structures/components already described. Accordingly, the structures/components having the same reference numbers may not be described again.

Still referring to FIG. 24, planter 420 is illustrated and characterized as having any number of sectional lines; only one sectional line 35 shown. Accordingly, body 24 of planter 420 has any number of sections; only two sections 26 and 28 shown. Any number of mechanical fasteners can be used for each sectional line. Illustrated are three different mechanical fasteners 422, 424 and 426. It should be understood that less than three, or more than three, mechanical fasteners can be used. Moreover, all the mechanical fasteners can be a different style or configuration as shown. Alternatively, two or more of the mechanical fasteners can be the same style or configuration. Still further, although the style or configuration of mechanical fasteners for this embodiment are latches, it should be understood any number of hinges can be included with mechanical fasteners 422, 424 and 426.

It should be understood that embodiments of the planters disclosed throughout this document can be devoid of any latches and/or hinges. To releasably secure the sections together of the body of the planter, this embodiment relies upon the support ring 20 secured under the rim collar 22. That is, the support ring 20 is the mechanical fastener to secure and lock the sections of the body together in a closed orientation to establish the cavity which receives the plant. Each support cable 16 could still extend from the support ring 20.

In compliance with the statute, the various embodiments have been described in language more or less specific as to structural and methodical features. It is to be understood, however, that the various embodiments are not limited to the specific features shown and described, since the means herein disclosed comprise disclosures of putting the various embodiments into effect. The various embodiments are, therefore, claimed in any of its forms or modifications within the proper scope of the appended claims appropriately interpreted in accordance with the doctrine of equivalents.

The invention claimed is:

1. An upside-down planter comprising:
a body having an upper end opposite a lower end, the body comprising at least two separate and discrete sections secured together to define a cavity;
support cables secured to the upper end of the body;
an opening in the lower end of the body configured to receive a portion of a plant; and
at least one mechanical fastener releasably securing the at least two sections of the body together.

2. The upside-down planter of claim 1 wherein the at least two sections define two sectional lines in the body, each sectional line has at least one mechanical fastener over the sectional line.

3. The upside-down planter of claim 2 wherein at least one of the two sectional lines has a plurality of mechanical fasteners over the at least one sectional line.

4. The upside-down planter of claim 2 wherein one mechanical fastener over one sectional line comprises a latch and wherein the other mechanical fastener over the other sectional line comprises a hinge.

5. The upside-down planter of claim 1 wherein the at least two sections define two sectional lines in the body, and wherein the at least one mechanical fastener comprises a single mechanical fastener over the at least two sectional lines securing the at least two sections together.

6. The upside-down planter of claim 5 wherein the single mechanical fastener comprises a retaining ring.

7. The upside-down planter of claim 1 wherein the body comprises at least three separate and discrete sections secured together to define the cavity.

8. The upside-down planter of claim 1 wherein the at least one mechanical fastener comprises a single mechanical fastener securing the at least two sections together.

9. The upside-down planter of claim 1 wherein the at least one mechanical fastener comprises a plurality of mechanical fasteners securing the at least two sections together.

10. The upside-down planter of claim 1 wherein the at least one mechanical fastener comprises a plurality of latches securing the at least two sections together.

11. The upside-down planter of claim 1 wherein the at least one mechanical fastener comprises at least one latch and at least one hinge securing the at least two sections together.

12. The upside-down planter of claim 1 further comprising a swivel loop at the terminal ends of the support cables opposite the upper end of the body, the swivel loop is capable of rotating 360 degrees.

13. An upside-down planter comprising:
a body having an upper end opposite a lower end, the body comprising at least two separate and discrete sections secured together to define a cavity;
an opening in the lower end of the body configured to receive a portion of a plant;
at least one mechanical fastener retained at the upper end of the body, the at least one mechanical fastener releasably securing the at least two sections of the body together; and
support cables secured to the at least one mechanical fastener.

14. The upside-down planter of claim 13 wherein the at least one mechanical fastener comprises a support ring.

15. The upside-down planter of claim 13 further comprising a rim collar at the upper end of the body, and wherein the at least one mechanical fastener is retained under the rim collar.

16. The upside-down planter of claim 15 wherein the support cables extend through the rim collar to be secured to the at least one mechanical fastener.

17. The upside-down planter of claim 15 wherein the at least one mechanical fastener comprises a support ring.

18. The upside-down planter of claim 13 further comprising at least one additional mechanical fastener secured over the body and spaced from the upper end of the body.

19. An upside-down planter comprising:
a body having an upper end opposite a lower end, the body comprising at least two separate and discrete sections secured together to define a cavity;
an opening in the lower end of the body configured to receive a portion of a plant;
a plurality of rings surrounding the body, the plurality of the rings releasably securing the at least two sections of the body together; and
support cables secured to the upper end of the body.

20. The upside-down planter of claim 19 wherein one of the plurality of rings is secured to the upper end of the body, and wherein the support cables slidingly engage the one of the plurality of rings.
